(19) United States
(12) Patent Application Publication
(10) Pub. No.: US 2005/0162802 A1
(43) Pub. Date: Jul. 28, 2005

(54) Offset gap control for electromagnetic devices

(75) Inventors: Leonard Wai Fung Kho, San Francisco, CA (US); Alex Ka Tim Poon, San Ramon, CA (US)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Nikon Research Corporation of America

(21) Appl. No.: 10/764,155

(22) Filed: Jan. 22, 2004

(51) Int. Cl. H01H 47/00

(52) U.S. Cl. 361/139

(57) ABSTRACT

A stage apparatus includes a first assembly including a target member, a second assembly including a first attracting member and a second attracting member located on opposite sides of the target member, and an actuator associated with the second assembly. The actuator of the stage apparatus moves the second assembly to adjust the relative distance between the target member and the first attracting member.

### BACKGROUND OF THE INVENTION

1. Field of the Invention

This invention relates to control systems, particularly those used to optimize gap sizes between electromagnetic devices with minimal power usage. The control systems of the invention are applicable to semiconductor processing equipment, such as a scanning stage apparatus.

2. Description of Related Art

Electromagnetic devices are well known. One example of a known electromagnetic device is an E-I core device, which is a type of electromagnetic linear motor so named because of its two main components. The first component is the E-core, which is a three-barrel structure having a shape that resembles the letter “E” with an insulated electric coil wire wound around the center bar and a source of current supplying current to the coil. Current running through the coil creates an electromagnetic field that attracts an associated I-shaped core. Thus, an electromagnetic force is exerted across the width of a gap between the E-core and the I-core. The smaller the gap is in an electromagnetic device, the more efficient the force output is with respect to power usage.

Precise movements of objects are frequently needed in machining, lithography, and other strict-tolerance manufacturing applications, e.g., in stepper and scanner machines used in the semiconductor industry. Typically, the goal is to provide precise adjustment of, for instance, a sample or work piece stage in three dimensions.

Fine stages are often used in the semiconductor field for moving reticles (masks) and wafers in lithography systems. Such systems often include a primary exposure source, a mask, a positioning system, a projection system, and a control system. The intent typically is to illuminate a wafer coated with a layer of radiation-sensitive material so as to produce the desired circuit pattern. Fine stages are generally used to accurately position a mask for exposure. During a scan, the fine stage may move and reset the mask to its original position several times.

A particularly useful stage setup for lithography systems is a dual-force-mode fine stage, which includes a coarse stage and a fine stage. Information about dual-force-mode fine stage apparatus can be found in U.S. Publication No. 2002/0185983, entitled “Dual Force Mode Fine Stage Apparatus,” incorporated herein by reference in its entirety.

In a dual-force-mode fine stage apparatus, the coarse stage used to accelerate and decelerate the fine stage is a high efficiency device, such as an E-I core that generates a large amount of force. The I-core section of the coarse stage may be attached to a fine stage. The attraction between the E-core and I-core drives the stage movements. Examples of an E-I core actuator and an associated control system can be found in U.S. Pat. No. 6,069,417, entitled “Stage Having Paired E/I Core Actuator Control,” which is incorporated herein by reference in its entirety.

Because E-I core devices are only attractive, opposing E-I pairs can be used to generate opposing forces. One common setup of opposing E-I pairs is described as an E-IIE setup, where each E-I pair works as an actuator with preset gap distances.

Another setup is an E-I-E set up, which has two E-cores on opposite sides of a single I-core. In standard configurations, the gap distance between the E-I pairs is what is determined by the original mechanical setup. Often in manufacturing a large gap between the two E-cores will ease manufacturing constraints. A large gap leads to the need for additional current for the coil of the E-core. Thus, what is needed is the ability to manipulate the gap distance for each E-I pair. This manipulation, called offset gap control, allows the use of a larger mechanical gap setup, which may ease manufacturing constraints, while still maintaining a minimal energy output during its use as an actuator. Thus, there is also a need for a method of manipulating the gap distance between E-I core pairs in an E-I-E electromagnetic device.

### SUMMARY OF THE INVENTION

In one embodiment consistent with the invention, an apparatus comprises: a first attracting member opposing a second attracting member; at least one target member situated between the first attracting member and the second attracting member; at least one actuator that moves at least one of the first attracting member, the second attracting member, and the target member, so as to adjust the distance between the target member and at least one of the first and second attracting members; at least one sensor that detects a gap between the target member and at least one of the first and second attracting members; and a controller coupled to the actuator to adjust the size of the gap between the target member and at least one of the first and second attracting members.

In another embodiment consistent with the invention, a method of moving a fine stage device comprises: connecting a fine stage device to a coarse stage device, the coarse stage device comprising an attracting framework comprising opposing attracting members and at least one target member, wherein the target member is located in a gap between the attracting members and connected to the fine stage device; and manipulating the relative position of the target member by moving the attracting framework to decrease the distance between one of the attracting members and the target member.

In another embodiment consistent with the invention, a dual-force-mode fine stage apparatus comprises: a first assembly including a target member; a second assembly including a first attracting member and a second attracting member located on opposite sides of the target member; and an actuator associated with the second assembly, wherein the actuator moves the second assembly to adjust the relative distance between the target member and the first attracting member.

In another embodiment consistent with the invention, a dual-force-mode stage assembly comprises: a fine stage assembly; a coarse stage assembly; a sensor configured to detect a position of the target member so that the relative distance between the target member and the attracting members can be determined; and a controller coupled to the coarse actuator of the coarse stage assembly to control the position of the attracting members. Specifically, the coarse stage assembly comprises: opposing attracting members, each capable of drawing an electric current, with a gap between the attracting member elements; and a target member in the gap, the target member being connected to the fine stage assembly. In addition, the coarse stage assembly is moveable along an axis independently of the fine stage assembly by means of a coarse actuator.

In another embodiment consistent with the invention, a stage device comprises a table that retains an object; a first attracting member opposing a second attracting member; at least one target member situated between the first attracting member and the second attracting member, wherein the table is attached to at least one of the first attracting member, the second attracting member, and the target member; at least one actuator that moves at least one of the first attracting member, the second attracting member, and the target member, so as to adjust the distance between the target member and at least one of the first and second attracting members; at least one sensor that detects a gap between the target member and at least one of the first and second attracting members; and a controller coupled to the actuator to adjust the size of the gap between the target member and at least one of the first and second attracting members.

In another embodiment consistent with the invention, an exposure apparatus comprises: an illumination system that irradiates radiant energy; and a stage device that carries an object disposed on a path of the radiant energy. Specifically, the stage device comprises: a table that retains the object; a first attracting member opposing a second attracting member; at least one target member situated between the first attracting member and the second attracting member, wherein the table is attached to at least one of the first attracting member, the second attracting member, and the target member; at least one actuator that moves at least one of the first attracting member, the second attracting member, and the target member, so as to adjust the distance between the target member and at least one of the first and second attracting members; at least one sensor that detects a gap between the target member and at least one of the first and second attracting members; and a controller coupled to the actuator to adjust the size of the gap between the target member and at least one of the first and second attracting members.

In another embodiment consistent with the invention, a method for operating an exposure apparatus includes employing a stage device to position an object. Specifically, the stage device comprises: a table that retains the object; a first attracting member opposing a second attracting member; at least one target member situated between the first attracting member and the second attracting member, wherein the table is attached to at least one of the first attracting member, the second attracting member, and the target member; at least one actuator that moves at least one of the first attracting member, the second attracting member, and the target member, so as to adjust the distance between the target member and at least one of the first and second attracting members; at least one sensor that detects a gap between the target member and at least one of the first and second attracting members; and a controller coupled to the actuator to adjust the size of the gap between the target member and at least one of the first and second attracting members.

In another embodiment consistent with the invention, a method for making a micro-device includes a photolithography process using the stage device noted above to position an object.

In another embodiment consistent with the invention, a method for making a semiconductor device on a wafer includes operating an exposure apparatus via the stage device noted above to position an object.

It is to be understood that both the foregoing general description and the following detailed description are exemplary and explanatory only and are not restrictive of the embodiments of the present invention, as claimed.

### BRIEF DESCRIPTION OF THE DRAWINGS

The accompanying drawings are included to provide a further understanding of the invention and are incorporated in and constitute a part of this specification. The drawings illustrate embodiments of the invention and, together with the description, serve to explain the principles of the invention. In the drawings:

FIG. 1 illustrates an E-I core device consistent with an embodiment of the invention;

FIG. 2 illustrates an E-I-E Core assembly consistent with an embodiment of the invention;

FIG. 3 illustrates a stage device using an E-I-E core assembly in position in proof-of-concept hardware consistent with an embodiment of the invention;

FIGS. 4A-4B illustrate acceleration and deceleration positions of a dual-force-mode device consistent with an embodiment of the invention;

FIG. 5 is a block diagram of a controller consistent with an embodiment of the invention;

FIGS. 6A-6B are graphs showing acceleration trajectory and gap distance consistent with an embodiment of the invention;

FIG. 7 is a flow diagram of the offset gap control consistent with an embodiment of the invention;

FIG. 8 illustrates a photolithography apparatus consistent with an embodiment of the invention;

FIG. 9 shows a flow diagram illustrating the general manufacturing process of semiconductor devices consistent with an embodiment of the invention; and

FIG. 10 shows a flow diagram illustrating the steps associated with wafer processing consistent with an embodiments of the invention.

### DETAILED DESCRIPTION

Reference will now be made in detail to certain embodiments of the present invention, examples of which are illustrated in the accompanying drawings.

In one embodiment of the invention, during the use of one E-I pair in an E-I-E assembly, the gap between the E element and the I element in the E-I pair is controlled to be smaller than the size determined by the initial mechanical set-up.

Embodiments of the present invention may be implemented in connection various types of the E-I core electromagnetic assemblies. By way of a non-limiting example, an exemplary implementation will be described with reference to a dual-force-mode fine stage device, having an E-I-E electromagnetic assembly as one of the actuators between the fine stage and the coarse stage.

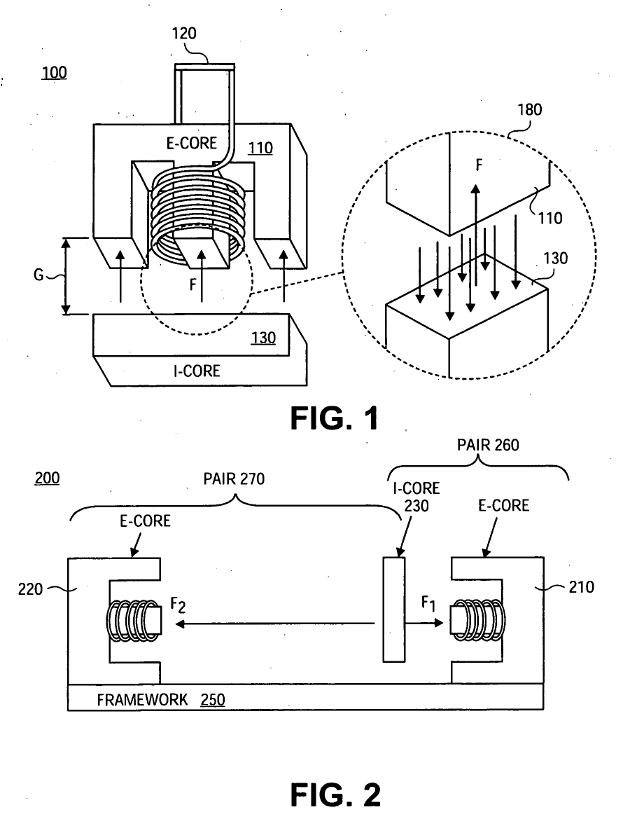

FIG. 1 shows in a perspective view an E-I core device used in accordance with one embodiment of this invention. The E-I core device has three main components, an E-core 110, a coil 120, an I-core 130.

E-core, or attracting member, 110 may be any type of magnetically permeable material for use with a coil, such as iron, which has the shape of a letter “E” with an insulated electric coil (wire) 120 wound around the center bar of the E and a source of electric current to the coil (not shown). In other embodiments, for example, the E-core may be a “C”-shaped core or multi-pronged core. Coil 120 may be any coil that creates a circulating magnetic field. I-core, or target member, 130 may be any type of magnetically permeable material capable of responding to a force field generated by coil 120. In one embodiment, I-core 130 may be connected to a material body, such as a fine stage. As shown in FIG. 1, when a current runs through the coil associated with E-core 110, the electromagnetic force F is exerted across the width of a gap G.

The well-known properties of the E-I core assembly shown in FIG. 1 may be used in accordance with this invention as shown in FIG. 2. It is to be understood that the actual stage or object 200 typically moves on a base on which it is supported by a bearing system such as roller or air bearings. The assembly of FIG. 2 is a coarse stage connected to fine stage (not shown). The coarse stage 200 typically is guided by some sort of guide rails or guide structure mounted, for example, on the base structure (not shown). Only one degree of freedom of movement along the X-axis is shown in FIG. 2, but other directions of movement are possible.

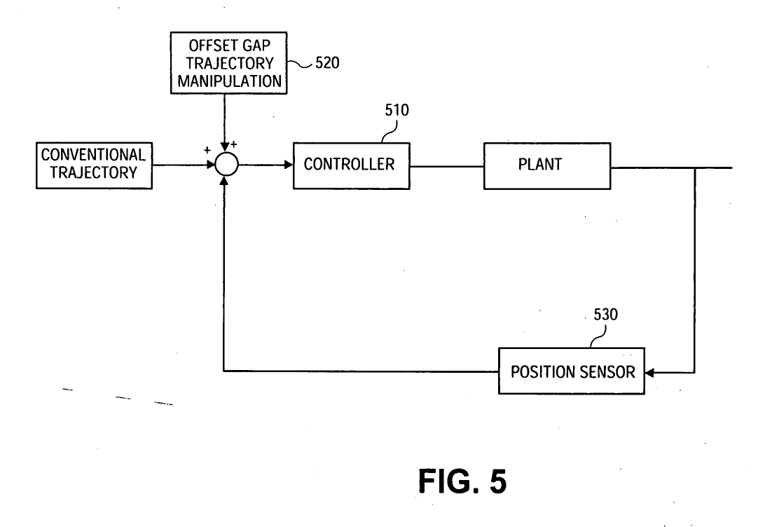

In one embodiment, the coarse stage assembly includes first E-core 210, second E-core 220, and framework 250. E-cores 210 and 220 may each include a core member and a coil assembly disposed near the core member. And one or more controllers, such as the controller 510 shown in FIG. 5, may provide currents to the coil assemblies to generate desired accelerating or decelerating forces. First E-core 210 and second E-core 220 are firmly attached to framework 250, and I-core 230 is attached to a fine stage (not shown). This configuration can be reversed to have the I-core attached to the framework and each E-core moveable, either separately or jointly. An actuator (not shown) is fixed to framework 250 or a part of it. Both first E-core 210 and second E-core 220 use the moveable I-core 230 to create an E-I core pair. As shown in FIG. 2, first E-core 210 and moveable I-core 230 comprise pair 260. A current running in the coil of first E-core 210 generates an attractive force F1. Similarly, second E-core 220 and I-core 230 comprise pair 270. A current running in the coil of second E-core 220 generates an attractive force F2.

The fine stage connected to I-core 230 accelerates under force F1 from pair 260 and decelerates under force F2 from pair 270. The amount of movement is determined by the magnitudes of forces F1 and F2, respectively a function of the current applied to the corresponding E-core and of the corresponding gap distance.

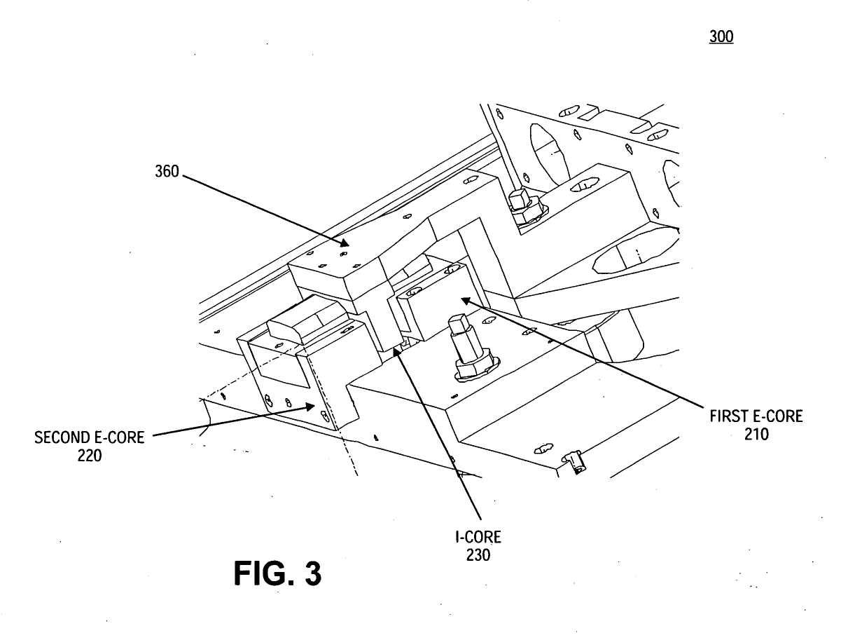

FIG. 3 illustrates a stage device using an E-I-E core assembly consistent with the invention. The fine stage and I-core are connected through I-core connector 360. The coarse stage can be moved by an actuator (not shown) connected between the coarse stage and another stage or ground.

Offset gap control works by manipulating the relative positions between the E-cores and I-core. In one embodiment, the I-core is attached to the fine stage, the two E-cores are connected to a framework, and the framework is moved to manipulate the gap distances in the E-core and I-core pairs. This does not affect the trajectory of the fine stage. In another embodiment, the I-core position is manipulated. In yet another embodiment, the position of each E-core is independently manipulated. An actuator or actuators attached to the coarse stage may be used to perform the position manipulation.

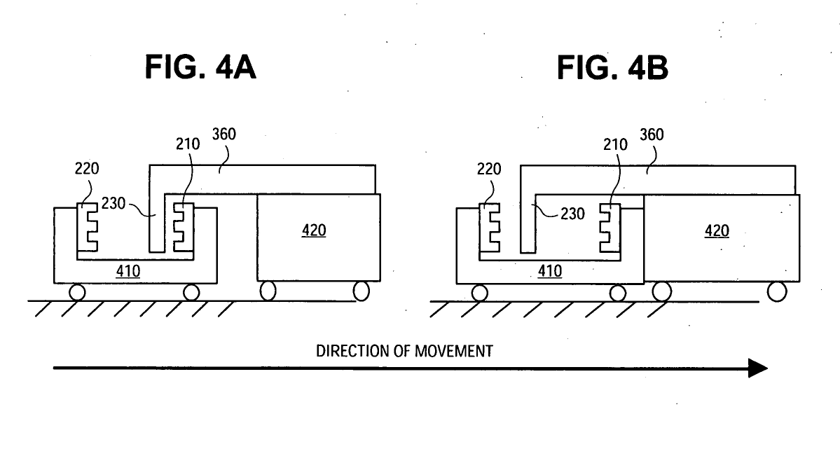

FIGS. 4A-4B illustrate acceleration and deceleration positions consistent with an embodiment of the invention. FIG. 4A shows stage system including coarse stage 410, fine stage 420, coarse stage actuator 430, and fine stage actuator 440. Both coarse stage 410 and fine stage 420 are movable on guide surface 450A of base member 450, which remains still. Coarse stage actuator 430, a linear motor utilizing a Lorentz force in one embodiment, is coupled between coarse stage 410 and base member 450. Coarse stage actuator 430 moves coarse stage 410 relative to base member 450. Fine stage actuator 440 is coupled between coarse stage 410 and fine stage 420, and moves fine stage 420 relative to coarse stage 410 independently from E-I pairs 260 and 270. FIG. 4A further shows coarse stage 410 with a starting position having a small gap between E-I pair 260, the pair for providing force during acceleration. During the constant velocity portion of the trajectory, coarse stage 410 slowly moves to the position illustrated in FIG. 4B without affecting the trajectory of fine stage 420. FIG. 4B shows coarse stage 410 at a position with a small gap between E-I pair 270, the pair for providing force during deceleration. The initial gap between the first E-core and the second E-core may be mechanically set up to be large. The position of the I-core is moved in this gap. Neither E-I pair is active during the constant velocity portion of the trajectory, while fine stage actuator 440, a voice coil motor for instance, is responsible for positioning the fine stage. The gap between one of the E-cores and the I core is set by the coarse stage actuator 430 during this time.

A control system for controlling the coarse stage positioning of FIG. 4 is shown in the form of a block diagram in FIG. 5. FIG. 5 depicts the control apparatus and its operation in the form of a feedback control loop. In addition to what is shown in FIG. 4, a coarse stage actuator is provided for controlling the coarse stage. In one embodiment, at least one position sensor (not shown) is associated with the coarse stage, so that the relative distance between the E-core and the I-core of each E-I pair can be measured. Alternatively, multiple sensors can be employed to measure the positions of various elements, i.e. the first E-Core, the second E-core, and the I-core, and the relative E-I gap distance can be calculated from their positions. As an example, the sensors may be interferometers, cap sensors, or optical sensors. Those sensors may send position information to controllers to control the positions of those elements, and, therefore, may be used for the manipulating relative gap distance.

The control loop for coarse stage shown in FIG. 5 includes an offset gap trajectory manipulation 520 that manipulates the actuator to move the coarse stage to the desired position. Controller 510 determines the output to the actuator necessary to reach the desired coarse stage position at plant 540, which may have a fine stage associated with it. Specifically, this microprocessor is part of a feedback loop controlling the actuator, which receives data indicative of the position of the elements from position sensor 530 and feeds the position data back to the controller so that the stage reaches its intended position. Position sensor 530 may be comprised of one or more sensors. A microprocessor or a micro controller is not required to carry out the functions of FIG. 5. This process may be performed, for instance, by hard-wired circuitry or other control circuitry. Alternatively, a computer may perform those functions.

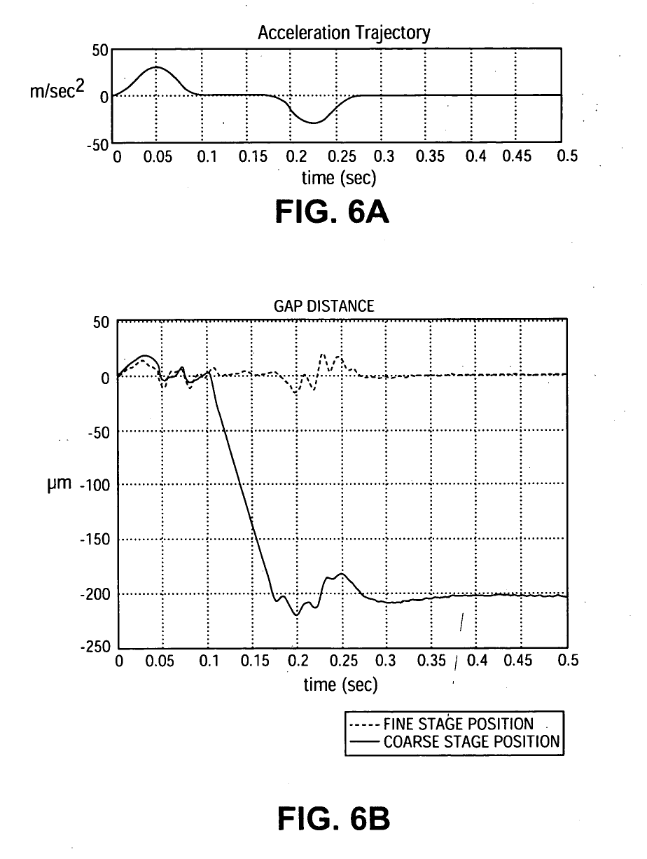

FIG. 6A is a graph of the acceleration trajectory in a dual-force-mode device. The graph shows acceleration at time 0 to 0.1, a constant velocity between 0.1 and 0.175, and deceleration at time 0.175 to 0.275. FIG. 6B is a graph illustrating the relative gap distance between the fine stage position and the coarse stage position. The graph shows that during time 0 to 0.1, the fine stage and the coarse stage have a starting reference gap position of 0. Then, from time 0.1 to 0.175, during the constant velocity period, the coarse stage is moving independently of the fine stage to a new relative gap position of about −200 μm. After time 0.175, the fine stage and the coarse stage move together with a constant gap, but with the coarse stage in a different position. The position at starting reference point 0 reflects the small gap between the first E-I core pair, the acceleration pair. The relative position of −200 μm reflects the small gap between the second E-I core pair, the deceleration pair.

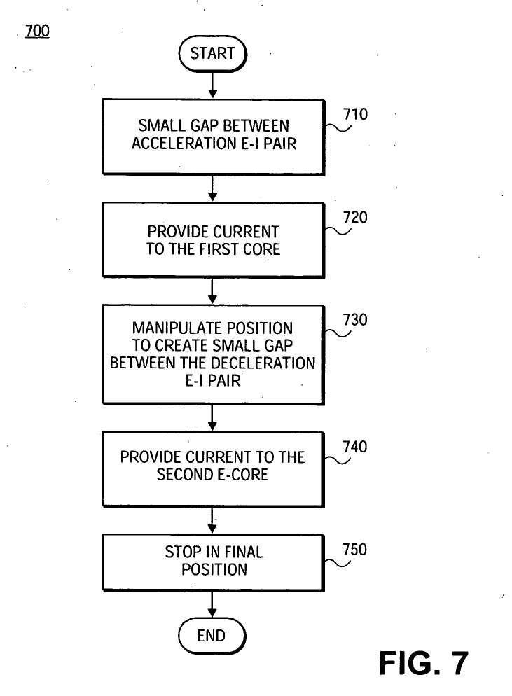

FIG. 7 is a flow diagram of offset gap control consistent with an embodiment of the invention. First, both the fine stage and the coarse stage are moved to a position where the E-I gap between E-I pair 260, the acceleration E-I pair, is small (step 710). When acceleration starts, a current is provided to the first E-core 210 to generate the desired force. The relative position between the E-core and the I-core is measured during the acceleration in order to calculate the current required to generate the necessary force for moving the fine stage (step 720).

During the constant velocity phase, coarse stage actuators manipulate the positions of the E-cores relative to the I core, such that the gap between E-I pair 270, responsible for deceleration, becomes small before the deceleration phase (step 730).

During the deceleration phase, current is provided to the second E-core 220 to generate the desired force. The gap between the second E-core 220 and I-core is measured during the deceleration in order to calculate the necessary current required for the second E-core 220 (step 740). When the device is in the final position, no more current is provided to either E-I core pair (step 750).

The stage apparatus of the invention may be used as a scanning stage device in photolithography apparatus. For example, a stage device may include a table, which supports or retains an object, and the table may be attached to at least one of first E-core, the second E-core, and the I-core. The object maybe one that requires precise positioning, such as a mask (reticle) for a photolithography apparatus or a wafer to be exposed with certain patterns. Accordingly, the table may be a wafer stage or a reticle stage. Specifically, an exposure apparatus may employ the stage device to carry an object disposed on a path of radiant energy irradiated from an illumination system. Accordingly, methods for operating an exposure apparatus may include using the stage device to position an object. Also, photolithography process using the stage device to position an object may be employed to make micro-devices, such as to make semiconductor devices on a wafer.

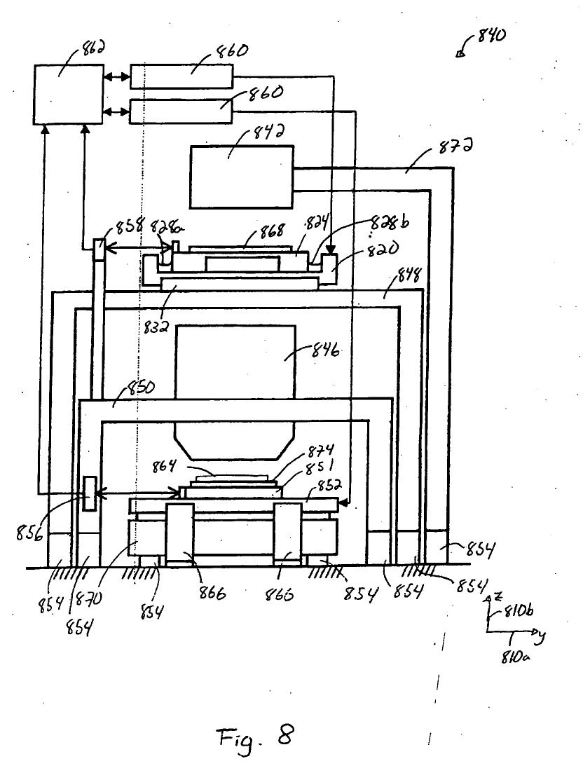

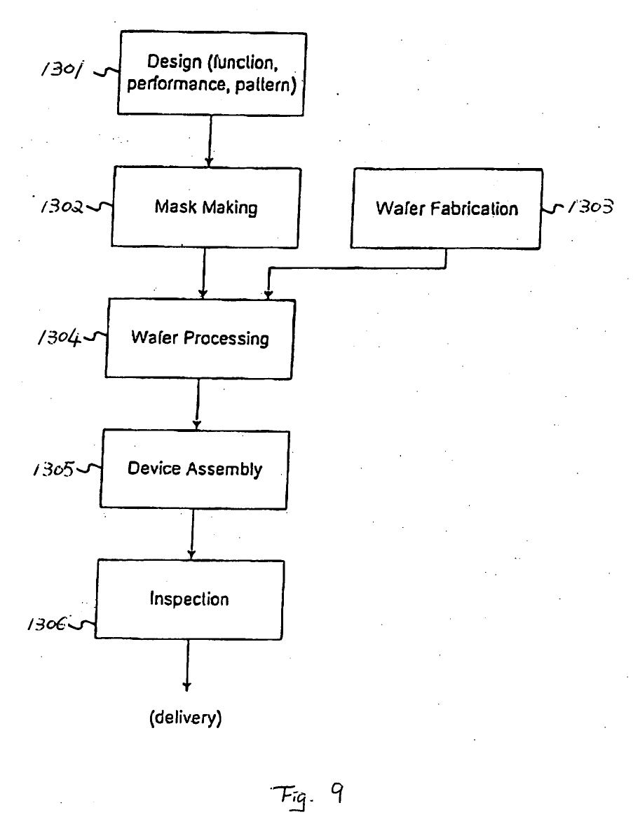

FIG. 8 illustrates a photolithography apparatus including an overall reticle scanning stage device with dual-force-mode capabilities. Photolithography apparatus (exposure apparatus) 840 includes a wafer positioning stage 852 and a wafer table 851. Wafer positioning stage 852 may be driven by a planar motor (not shown), and wafer table 851 may be magnetically coupled to wafer positioning stage 852. In one embodiment, wafer positioning stage 852 may include a wafer coarse stage and a wafer fine stage, which include dual-force-mode capabilities. In one embodiment, wafer positioning stage 852 may use the stage apparatus consistent with the invention.

The planar motor driving wafer positioning stage 852 may employ an electromagnetic force generated by magnets and corresponding armature coils arranged in two dimensions. A wafer 864 is held in place on a wafer holder 874, which is coupled to wafer table 851. Wafer positioning stage 852 is arranged to move in multiple degrees of freedom, e.g., between three to six degrees of freedom, under the control of a control unit 860 and a system controller 862. The movement of wafer positioning stage 852 allows positioning of wafer 864 at a desired position and a desired orientation relative to a projection optical system 846.

Wafer table 851 may be levitated in z-direction 810b by any number of voice coil motors (not shown), e.g., three voice coil motors. In one embodiment, at least three magnetic bearings (not shown) couple with wafer table 851 and move it along y-axis 810a. The motor array of wafer positioning stage 852 may be supported by a base 870. Base 870 is supported from ground via isolators 854. Reaction forces generated by the movements of wafer positioning stage 852 may be passed to the ground through a frame 866 or absorbed by frame 866. Examples of a frame are described in Japanese Publication No. 8-166475 and U.S. Pat. No. 5,528,118, both incorporated herein by reference in their entireties.

An illumination system 842 is supported by a frame 872. Frame 872 is supported from the ground through isolators 854. Illumination system 842 includes an illumination source and is arranged to project a radiant energy, e.g., light, through a mask pattern on a reticle 868 that is supported by and scanned using a reticle stage. The reticle stage may include a coarse stage 820 and a fine stage 824. In one embodiment, the reticle stage may use the stage apparatus consistent with the invention. The radiant energy is focused through projection optical system 846, which is supported by a projection optics frame 850. The projection optics frame 850 is supported from the ground through isolators 854.

Coarse stage 820 and fine stage 824 are connected by cords 828a and 828b, which enable fine stage 824 to accelerate with coarse stage 820 in y-direction 810a. Specifically, when a linear motor 832 causes coarse stage 820 to accelerate in y-direction 810a, one of cords 828a and 828b, which is pulled into tension by the acceleration of coarse stage 820, causes fine stage 824 to accelerate. For example, when the acceleration is in positive y-direction 810a, cord 828b may be pulled into tension. Alternatively, when the acceleration is in a negative y-direction, a direction opposite to direction 810a, cord 828a may be pulled into tension. A stator of linear motor 832 is connected to a reticle stage frame 848. Therefore, reaction forces generated by the movements of coarse stage 820 and fine stage 824 may be passed to the ground through isolators 854 or absorbed by isolators 854. Examples of isolators are described in Japanese Publication No. 8-330224 and U.S. Pat. No. 5,874,820, both incorporated herein by reference in their entireties.

A first interferometer 856 is supported on projection optics frame 850 to detect the position of wafer table 851. Interferometer 856 outputs the position information of wafer table 851 to a system controller 862. A second interferometer 858 is supported on projection optics frame 850 to detect the position of coarse stage 820 or fine stage 824. Interferometer 858 also outputs position information to system controller 862.

It should be appreciated that there are different types of photolithographic apparatuses or devices. For example, photolithography apparatus 840 may be used as a scanning-type photolithography system, which exposes the pattern from reticle 868 onto wafer 864 with reticle 868 and wafer 864 moving substantially synchronously. In a scanning-type system, reticle 868 is moved perpendicularly with respect to an optical axis of a lens assembly (projection optical system 846) or illumination system 842 by coarse stage 820 and fine stage 824. Also, wafer 864 is moved perpendicularly to the optical axis of projection optical system 846 by positioning stage 852. Scanning of reticle 868 and wafer 864 generally occurs when reticle 868 and wafer 864 are moving substantially synchronously.

Alternatively, photolithography apparatus or exposure apparatus 840 may be a step-and-repeat type photolithography system, which exposes reticle 868 while both reticle 868 and wafer 864 are stationary, e.g., when neither a fine stage 820 nor a coarse stage 824 is moving. In one embodiment, wafer 864 is in a substantially the same position relative to reticle 868 and projection optical system 846 during the exposure of an individual field. Subsequently, between consecutive exposure steps, wafer 864 is moved by wafer positioning stage 852 perpendicularly to the optical axis of projection optical system 846 and reticle 868 for exposure. Following this process, the images on reticle 868 may be sequentially exposed onto separate fields of wafer 864, so that the next field of semiconductor wafer 864 is brought into position relative to illumination system 842, reticle 868, and projection optical system 846.

It should be understood that the use of photolithography apparatus or exposure apparatus 840 is not limited to a photolithography system for semiconductor manufacturing. For example, photolithography apparatus 840 may be used as a part of a liquid-crystal-display (“LCD”) photolithography system that exposes an LCD device pattern onto a rectangular glass plate or a photolithography system for manufacturing thin film devices and/or other devices. Furthermore, the present invention may also be applied to a proximity photolithography system that exposes a mask pattern by locating a mask and a substrate without the use of a lens assembly. Additionally, the present invention provided herein may be used in other devices including, but not limited to, other semiconductor processing equipment, machine tools, metal cutting machines, and inspection machines.

The illumination source of illumination system 842 may be a g-line (436 nm), an i-line (365 nm), a KrF excimer laser (248 nm), a ArF excimer laser (193 nm), or an F₂-type laser (157 nm). Alternatively, illumination system 842 may use charged particle beams, such as x-ray and electron beams. For example, if an electron beam is used, thermionic emission type lanthanum hexaboride (LaB₆) or tantalum (Ta) may be used as an electron gun. Furthermore, if an electron beam is used, a pattern may be formed on a substrate with or without the use of a mask.

With respect to projection optical system 846, when far ultra-violet rays, such as an excimer laser, is used, glass materials such as quartz and fluorite that transmit far ultraviolet rays may be used. When either an F₂-type laser or an x-ray is used, projection optical system 846 may be either catadioptric or refractive (a reticle may be of a corresponding reflective type). When an electron beam is used, electron optics may comprise electron lenses and deflectors. As will be appreciated by those skilled in the art, the optical path for the electron beams is generally in a vacuum.

In addition, with an exposure device that employs vacuum ultra-violet (VUV) radiation of a wavelength that is approximately 200 nm or shorter, a catadioptric-type optical system may be considered. Examples of a catadioptric-type optical system may include, but are not limited to, those described in Japanese Publication No. 8-171054 and its U.S. counterpart, U.S. Pat. No. 5,668,672, and Japanese Publication No. 10-20195 and its U.S. counterpart, U.S. Pat. No. 5,835,275, all of them incorporated herein by reference in their entireties. In those examples, the reflecting optical device may be a catadioptric-type optical system incorporating a beam splitter and a concave mirror. In addition, Japanese Publication No. 8-334695 and its U.S. counterpart, U.S. Pat. No. 5,689,377, and Japanese Publication No. 10-3039 and its U.S. counterpart, U.S. Pat. No. 5,892,117, are incorporated herein by reference in their entireties. They describe examples of a reflecting-refracting type optical system that incorporate a concave mirror without a beam splitter, and those examples may be used in the systems noted above.

Furthermore, when linear motors are used in photolithography systems for a wafer stage or a reticle stage, the linear motors may be an air levitation type that employs air bearings or a magnetic levitation type that uses Lorentz forces or reactance forces. Examples of linear motors are described in U.S. Pat. Nos. 5,623,853 and 5,528,118, both incorporated herein by reference in their entireties. Additionally, the stage may also move along a guide, or may be a guideless type stage which uses no guide.

Alternatively, a wafer stage or a reticle stage may be driven by a planar motor, which drives a stage through the use of electromagnetic forces generated by a magnet unit that has magnets arranged in two dimensions and an armature coil unit that has coil in facing positions in two dimensions. With this type of drive system, one of the magnet unit or the armature coil unit is connected to the stage, while the other is mounted on the moving plane side of the stage.

Movement of the stages as described above generates reaction forces which may affect the performance of the overall photolithography system. Reaction forces generated by the wafer (substrate) stage movements may be passed to the ground through or absorbed by a frame member noted above, as well as those described in U.S. Pat. No. 5,528,118 and Japanese Publication No. 8-166475. Additionally, reaction forces generated by the reticle (mask) stage movements may be passed to the ground through or absorbed by a frame member, examples of it are described in U.S. Pat. No. 5,874,820 and Japanese Publication No. 8-330224, both incorporated herein by reference in their entireties.

As described above, a photolithography system may be built by assembling various subsystems in a manner that maintains mechanical, electrical, and optical accuracies. In order to maintain those accuracies, every optical system may be adjusted prior to and following assembly to achieve optical accuracy. Similarly, every mechanical system and every electrical system may be adjusted to achieve desired mechanical and electrical accuracies. The process of assembling subsystems into a photolithography system may include, but is not limited to, developing mechanical interfaces, electrical circuit wiring connections, and air pressure plumbing connections between subsystems. There is also a process where each subsystem is assembled before assembling a photolithography system from the various subsystems. Once a photolithography system is assembled using various subsystems, an overall adjustment is generally performed to ensure that substantially every desired accuracy is maintained within the overall photolithography system. Additionally, it may be desirable to manufacture an exposure system in a clean room where the temperature and humidity are controlled.

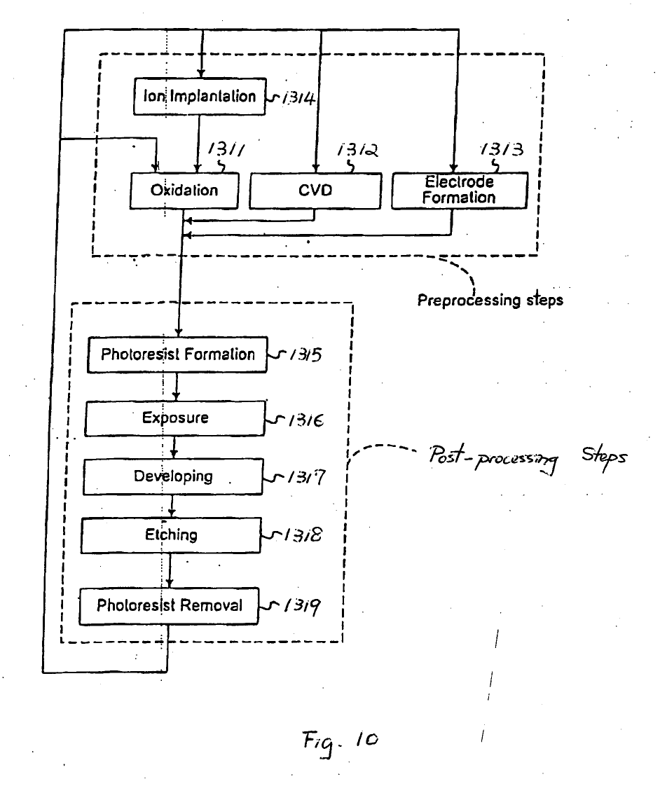

Semiconductor devices may be manufactured using one or more of the systems described above. FIG. 9 shows a flow diagram illustrating the general manufacturing process of semiconductor devices. Referring to FIG. 9, the process begins with step 1301, in which the function and performance characteristics of a semiconductor device are designed or otherwise determined. Next, in step 1302, a reticle (mask) having a pattern is designed according to the design of the semiconductor device. It should be appreciated that in a parallel step 1303, a wafer is made from a silicon material. In step 1304, the mask pattern designed in step 1302 is exposed onto the wafer fabricated in step 1303 via a photolithography system. As an example, the photolithography system may include a coarse reticle scanning stage and a fine reticle scanning stage that accelerates with the coarse reticle scanning stage as noted above. In one embodiment, the stage apparatus of the invention may be used in the photolithography system. A process of exposing a mask pattern onto a wafer will be described below. In step 1305, the semiconductor device is assembled. The assembly of the semiconductor device may include, but is not limited to, wafer dicing, bonding, and packaging processes. The completed device may be inspected in step 1306.

FIG. 10 shows a flow diagram illustrating the steps associated with wafer processing in manufacturing semiconductor devices consistent with the invention. In step 1311, the surface of a wafer is oxidized. In step 1312, a chemical vapor deposition (“CVD”) step, an insulation film may be formed on the wafer surface. Once the insulation film is formed, electrodes are formed on the wafer by vapor deposition in step 1313. Also, an ion implantation step 1314 may be used to implant ions. As will be appreciated by those skilled in the art, steps 1311-1314 are generally considered as preprocessing steps for wafers. Furthermore, it should be understood that various selections of processing variables in each step, such as the concentration and composition of various chemicals used in forming an insulation film in step 1312, may be made according to factors such as processing requirements, semiconductor device characteristics, and etc.

When preprocessing steps of wafers have been completed, post-processing steps may be implemented. Initially, photoresist is applied to a wafer in step 1315. In exposure step 1316, an exposure device may transfer the circuit pattern of a reticle to a wafer. Transferring the circuit pattern may include scanning a reticle scanning stage. In one embodiment, scanning the reticle scanning stage includes accelerating a fine stage with a coarse stage using a cord and accelerating the fine stage substantially independently from the coarse stage.

After the circuit pattern is transferred, the exposed wafer is developed in step 1317. Once the exposed wafer is developed, parts other than residual photoresist, e.g., the exposed material surface, may be removed by etching. In step 1319, any unnecessary photoresist remained after etching may be removed. As will be appreciated by those skilled in the art, multiple circuit patterns may be formed by repeating one or more of the preprocessing and the post-processing steps.

While cords are suitable for providing an overall reticle scanning stage device with dual-force-mode capabilities, it should be appreciated that cords are just one example of a “variable coupler,” i.e., a coupler between a coarse stage and a fine stage that may alternately be characterized by allowing high transmissibility between the stages and allowing relatively low transmissibility between the stages. Other suitable couplers include, but are not limited to, opposing motors which are coupled to substantially stationary amplifiers, and stops.

Other embodiments of the invention will be apparent to those skilled in the art from consideration of the specification and practice of the exemplary embodiments disclosed herein. Therefore, it is intended that the specification and examples be considered as exemplary only, with a true scope and spirit of the invention being indicated by the scope of the following claims and their equivalents.

1. An apparatus comprising:
a first attracting member opposing a second attracting member;
at least one target member situated between the first attracting member and the second attracting member;
at least one actuator that moves at least one of the first attracting member, the second attracting member, and the target member, so as to adjust the distance between the target member and at least one of the first and second attracting members;
at least one sensor that detects a gap between the target member and at least one of the first and second attracting members; and
a controller coupled to the actuator to adjust the size of the gap between the target member and at least one of the first and second attracting members.

2. The apparatus of claim 1, further comprising:
a fine stage device that adjusts the position of a stage, wherein the target member is connected to the fine stage device.

3. The apparatus of claim 2, wherein
at least one of the first and second attracting members comprises a core member and a coil assembly that is disposed near the core member; and
the controller provides a current to the coil assembly to generate a force that accelerates the fine stage device.

4. The apparatus of claim 2, wherein
at least one of the first and second attracting members comprises a core member and a coil assembly that is disposed near the core member; and
the controller provides a current to the coil assembly to generate a force that decelerates the fine stage device.

5. The apparatus of claim 2, wherein the actuator provides acceleration or deceleration of the fine stage through a pair of members formed by the target member and one of the first and second attracting members.

6. The apparatus of claim 1, further comprising a framework that connects the first attracting member and the second attracting member.

7. The apparatus of claim 6, wherein the actuator is connected to the framework.

8. The apparatus of claim 6, wherein moving the framework controls the gap.

9. A method of moving a fine stage device, the method comprising:
connecting a fine stage device to a coarse stage device, the coarse stage device comprising an attracting framework comprising opposing attracting members and at least one target member, wherein the target member is located in a gap between the attracting members and connected to the fine stage device; and
manipulating the relative position of the target member by moving the attracting framework to decrease the distance between one of the attracting members and the target member.

10. The method of claim 9, wherein at least one of the attracting members comprises a core member and a coil assembly that is disposed near the core member, and the method further comprises:
providing a current to the coil assembly to cause acceleration movement of the fine stage device.

11. The method of claim 9, wherein at least one of the attracting members comprises a core member and a coil assembly that is disposed near the core member, and the method further comprises:
providing a current to the coil assembly to cause deceleration movement of the fine stage device.

12. A dual-force-mode fine stage apparatus comprising:
a first assembly including a target member;
a second assembly including a first attracting member and a second attracting member located on opposite sides of the target member; and
an actuator associated with the second assembly, wherein the actuator moves the second assembly to adjust the relative distance between the target member and the first attracting member.

13. A dual-force-mode stage assembly comprising:
a fine stage assembly;
a coarse stage assembly, the coarse stage assembly comprising
opposing attracting members, each capable of drawing an electric current, with a gap between the attracting member elements; and
a target member in the gap, the target member being connected to the fine stage assembly,
wherein the coarse stage assembly is moveable along an axis independently of the fine stage assembly through a coarse actuator;
a sensor configured to detect a position of the target member so that the relative distance between the target member and the attracting members can be determined; and
a controller coupled to the coarse actuator of the coarse stage assembly to control the position of the attracting members.

14. A stage device comprising:
a table that retains an object;
a first attracting member opposing a second attracting member;
at least one target member situated between the first attracting member and the second attracting member, wherein the table is attached to at least one of the first attracting member, the second attracting member, and the target member;
at least one actuator that moves at least one of the first attracting member, the second attracting member, and the target member, so as to adjust the distance between the target member and at least one of the first and second attracting members;
at least one sensor that detects a gap between the target member and at least one of the first and second attracting members; and
a controller coupled to the actuator to adjust the size of the gap between the target member and at least one of the first and second attracting members.

15. An exposure apparatus comprising:
an illumination system that irradiates radiant energy; and
a stage device that carries an object disposed on a path of the radiant energy, wherein the stage device comprises:
a table that retains the object;
a first attracting member opposing a second attracting member;
at least one target member situated between the first attracting member and the second attracting member, wherein the table is attached to at least one of the first attracting member, the second attracting member, and the target member;
at least one actuator that moves at least one of the first attracting member, the second attracting member, and the target member, so as to adjust the distance between the target member and at least one of the first and second attracting members;
at least one sensor that detects a gap between the target member and at least one of the first and second attracting members; and
a controller coupled to the actuator to adjust the size of the gap between the target member and at least one of the first and second attracting members.

16. The exposure apparatus of claim 15, wherein the object comprises a wafer or a reticle.

17. A method for operating an exposure apparatus, the method comprising employing a stage device to position an object, wherein the stage device comprises:
a table that retains the object;
a first attracting member opposing a second attracting member;
at least one target member situated between the first attracting member and the second attracting member, wherein the table is attached to at least one of the first attracting member, the second attracting member, and the target member;
at least one actuator that moves at least one of the first attracting member, the second attracting member, and the target member, so as to adjust the distance between the target member and at least one of the first and second attracting members;
at least one sensor that detects a gap between the target member and at least one of the first and second attracting members; and
a controller coupled to the actuator to adjust the size of the gap between the target member and at least one of the first and second attracting members.

18. The method of claim 17, wherein the object comprises a wafer or a reticle.

19. A method for making a micro-device, the method comprising a photolithography process using a stage device to position an object, wherein the stage device comprises:
a table that retains the object;
a first attracting member opposing a second attracting member;
at least one target member situated between the first attracting member and the second attracting member, wherein the table is attached to at least one of the first attracting member, the second attracting member, and the target member;
at least one actuator that moves at least one of the first attracting member, the second attracting member, and the target member, so as to adjust the distance between the target member and at least one of the first and second attracting members;
at least one sensor that detects a gap between the target member and at least one of the first and second attracting members; and
a controller coupled to the actuator to adjust the size of the gap between the target member and at least one of the first and second attracting members.

20. The method of claim 19, wherein the object comprises a wafer or a reticle.

21. A method for making a semiconductor device on a wafer, the method comprising operating an exposure apparatus via a stage device to position an object, wherein the stage device comprises:
a table that retains the object;
a first attracting member opposing a second attracting member;
at least one target member situated between the first attracting member and the second attracting member, wherein the table is attached to at least one of the first attracting member, the second attracting member, and the target member;
at least one actuator that moves at least one of the first attracting member, the second attracting member, and the target member, so as to adjust the distance between the target member and at least one of the first and second attracting members;
at least one sensor that detects a gap between the target member and at least one of the first and second attracting members; and
a controller coupled to the actuator to adjust the size of the gap between the target member and at least one of the first and second attracting members.

22. The method of claim 21, wherein the object comprises a wafer or a reticle.

23. The method of claim 21, wherein the table comprises a wafer stage or a reticle stage.
